(19) United States
(12) Patent Application Publication
(10) Pub. No.: US 2004/0042942 A1
(43) Pub. Date: Mar. 4, 2004

(54) Continually stirred reactor system

(76) Inventor: Edward S. Siccardi JR., Downingtown, PA (US)

Correspondence Address: LYONDELL CHEMICAL COMPANY, 3801 WEST CHESTER PIKE, NEWTOWN SQUARE, PA, 19073, US

(21) Appl. No.: 10/233,806

(22) Filed: Sep. 3, 2002

(51) Int. Cl. B01J 8/00

(52) U.S. Cl. 422/209; 422/190; 422/224; 422/192; 422/225

(57) ABSTRACT

A reactor system 10 for use in chemical processing. The system 10 includes a reactor 12 having a longitudinal cylindrical bore 14 and a basket assembly 18 that is received in the bore so that the basket assembly is secured in relation thereto. The basket assembly includes an inner, generally cylindrical basket 20 and an outer, generally cylindrical basket 22 that is coaxial with the inner basket. The inner and outer baskets define an annular space 24 therebetween, the annular space being adapted to accommodate a granular catalyst 26. A rotatable shaft assembly 28 extends axially within the bore. The shaft assembly includes an upper end 30, a lower end 32 and a central section 34 extending therebetween. The upper and lower ends each have a pump 36,38 for directing flow of a chemical reagent 40 axially toward the central section upon rotation of the shaft assembly. The central section 34 is provided radially with extending blades 42 for urging flow of the reagent outwardly through the annular space between the baskets. The reactor system 10 promotes flow and mixing between the chemical reagent and the catalyst, thereby enhancing the kinetics of chemical reaction, control, and the reproducibility thereof.

### BACKGROUND OF THE INVENTION

1. Field of the Invention

This invention is directed to a continually stirred reactor system that is useful in promoting the intermixing of a solid granular catalyst and a liquid phase. The invention also includes a method for using such a reactor system.

2. Background Art

Various techniques have been deployed for the mixing of reagents in chemical processing. Techniques that include for example circulation of a liquid chemical reagent within an enclosed vessel are sometimes used. However, such approaches may be unable to circulate reagents adequately using commercially reasonable electrical power expenditures. Consequently, mixing at acceptable flow rates often leads to sub-optimal results, even when sufficient electrical power is used to energize a mixing system.

Catalysts are thought to be essential in virtually all industrial chemical reactions, especially in petroleum refining and synthetic organic chemical manufacturing. Since the activity of a solid catalyst is often centered on a small fraction of its surface, the number of active points can be increased by adding promoters which increase the surface area in one way or another, e.g. by increasing porosity. Such approaches, may also yield results that leave something to be desired. Illustrative of the prior art is U.S. Pat. No. 5,972,661 which issued to Kubera et al. on Oct. 26, 1999. That reference discloses a mass transfer system for mixing bulk liquid and gas in an upright tank. The '661 patent is incorporated herein by reference. It discloses a “draught tube” reactor, a simplified schematic of which is illustrated by FIG. 1 of that reference. The reactant slurry, including a solid catalyst, enters the central draught tube and is directed along its axis by impeller(s). A series of vertically oriented baffles positioned between the impellers prevents a swirling flow which might cause solid catalyst segregation. Upon reaching the end of the draught tube, the slurry flows in a counter-current direction through an annulus between the draught tube and the reactor wall. Product is continuously removed, and separated from an entrained catalyst, and worked up to remove solvent, byproducts, etc. The reactor has exhibited acceptable mass transfer rates. But catalyst separation issues have discouraged widespread commercial use.

It is also known that catalyst activity may be decreased by substances that tend to clog and weaken the catalyst surface. It would of course be desirable to avoid such adverse consequences.

### SUMMARY OF THE INVENTION

Against this background, it would be desirable to make available a reactor system that offers the favorable mass transfer characteristics of a draught tube reactor with less catalyst attrition.

It is a further object of the present invention to provide an improved impeller arrangement which promotes circulation of liquid chemical reagent within a cylindrical bore while offering efficiency in the power acquired to produce a required flow within the reactor system.

Accordingly, this invention pertains to a reactor system for use in chemical processing that meets these, and other objects. The system includes a reactor with a longitudinal cylindrical bore having a shaped bearing carrier. A basket assembly is received in the bore so that the basket is secured in relation thereto. The basket assembly has inner and outer concentric cylindrical baskets that are mounted in the bore of the reactor. Between the inner and outer basket there is defined an annular space which is adapted to accommodate and confine a granular catalyst therewithin.

A rotatable shaft assembly extends axially within the bore inside the inner basket. The shaft assembly has an upper end and a lower end. A central section extends between the upper and lower ends. The upper and lower ends each have a pump for directing flow of a chemical reagent toward the central section. Disposed within the central section are longitudinally oriented, radially extending blades that, when the shaft assembly rotates, urge flow of the reagent outwardly through the annular space and therefore the granular catalyst that is entrapped between the baskets.

The reactor system promotes flow and mixing between the chemical reagent and the catalyst, thereby enhancing the kinetics of chemical reaction, control, and the reproducibility thereof.

### BRIEF DESCRIPTION OF THE DRAWINGS

FIG. 1 is a side elevation view of a basket assembly according to the present invention before installation of the assembly within a reactor;

FIG. 2 is a cross-sectional, longitudinal view of the basket assembly after installation within the reactor, but before installation of a top cover;

FIG. 3 is a side elevational view, exploded, that illustrates the rotatable shaft assembly that is also depicted in FIG. 2;

FIG. 4 is also a side elevational view of the rotatable shaft assembly depicted in FIG. 3, illustrating a coupling thereof to members at the top and bottom ends thereof;

FIG. 5 resembles the view of FIG. 1, illustrating the positioning of the basket without the shaft assembly within the longitudinal cylindrical bore of the reactor system;

FIG. 6 is a top view of an upper end cap provided with apertures that permit the bore to be filled and emptied;

FIG. 7 is a top elevation view of the top side of the upper end cap;

FIG. 8 is an underside view thereof;

FIG. 9 is a top view of the lower screen plate; and

FIG. 10 is an underside view of the lower screen plate.

### DETAILED DESCRIPTION OF THE PREFERRED EMBODIMENT(S)

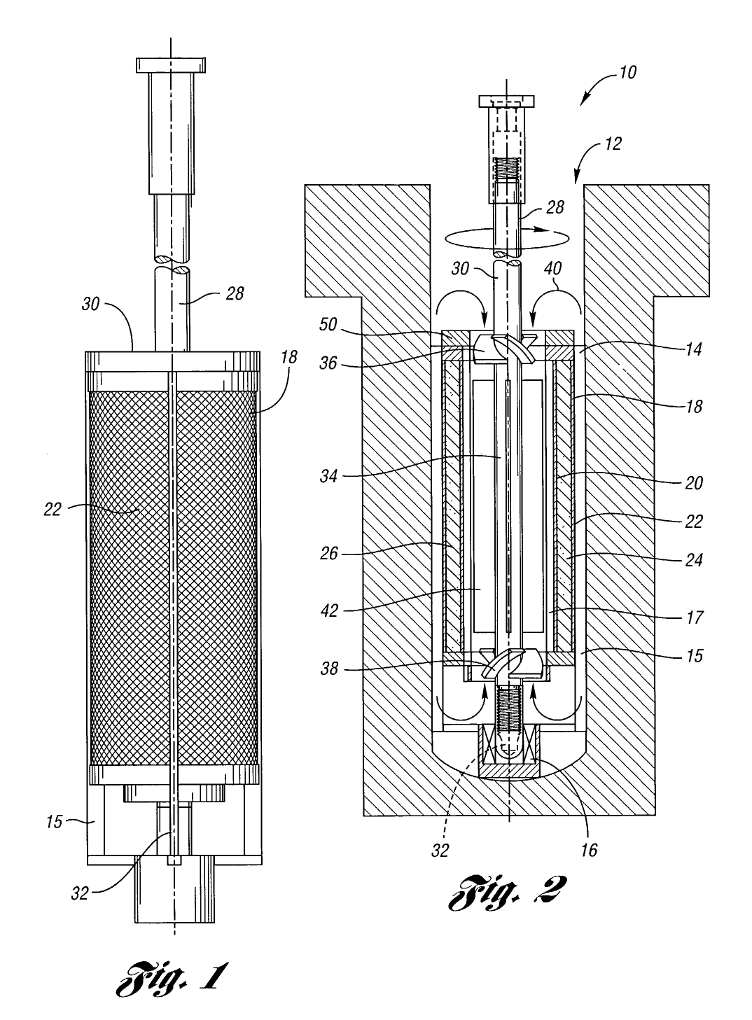

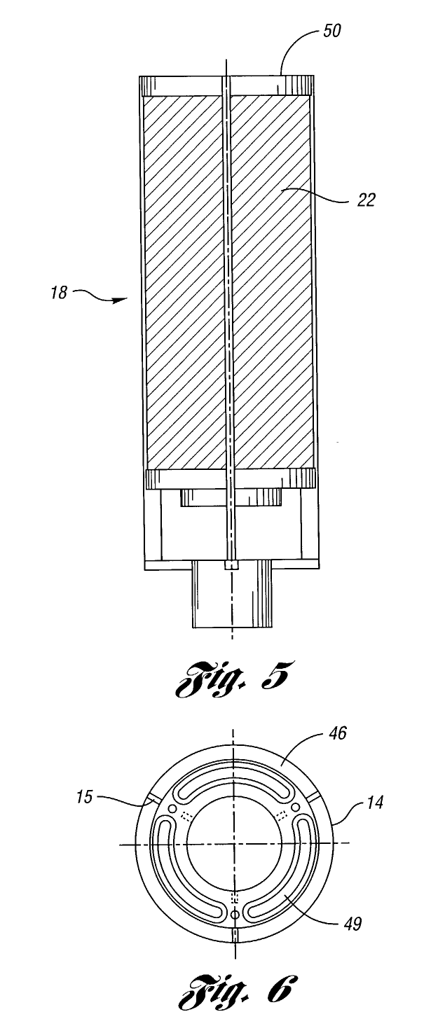

Turning first to FIGS. 1-2, there is depicted a basket assembly (FIG. 1) for use in a reactor system (FIG. 2) that is deployed in chemical processing where, for example, it is desirable to promote the kinetics of mixing between a liquid chemical reagent and a catalyst. The reactor system 10 includes a reactor 12 that has a longitudinal cylindrical bore 14 with a bearing carrier 16. The bearing carrier 16 is attached to three outer baffles 15 (FIGS. 1, 6). The longitudinal cylindrical bore 14 includes a bottom portion which curves smoothly into a center (FIG. 2). A basket assembly 18 (FIGS. 1-2) is received in the bore so that the basket assembly is secured in relation thereto. The basket assembly 18 is fixed inside the reactor bore 14 by friction between the three outer baffles 15 and the reactor wall.

As depicted, the basket assembly 18 include an inner, generally cylindrical basket 20 (FIG. 2), surrounding which is an outer, generally cylindrical basket 22 that is co-axial with its inner counterpart. Between the inner 20 and outer 22 baskets, there is defined an annular space 24 which is adapted to accommodate a granular catalyst 26 therewithin.

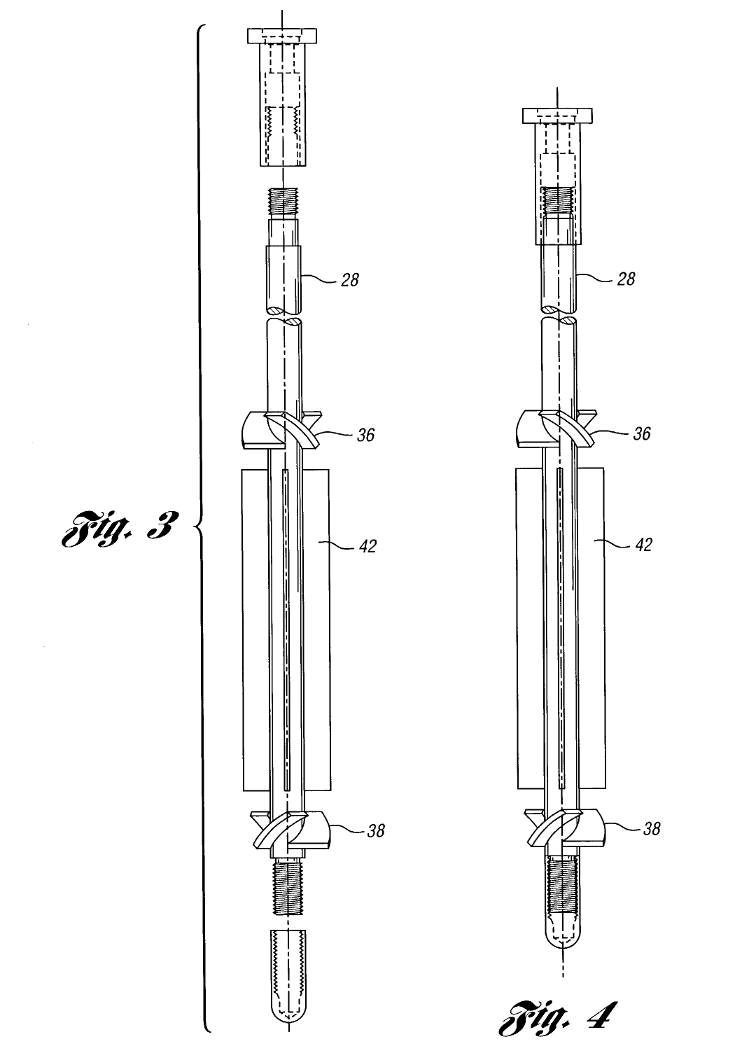

Additional detail of the shaft assembly is depicted in FIGS. 3-4. The rotatable shaft assembly 28 extends axially within the bore 14. The shaft assembly 28 includes an upper end 30, a lower end 32, and a central section 34 that extends therebetween. Disposed at each of the upper and lower ends 30, 32 of the rotatable shaft assembly is a pump or impeller 36, 38 which directs the flow of a chemical reagent 40. Under the influence of the pumps 36, 38, the chemical reagent 40 is propelled generally axially toward the central section 34. Extending radially outwardly from the central section 34 are blades 42 for urging flow of the reagent outwardly through the annular space 24 between the baskets 20, 22.

When the shaft assembly 28 is rotated in relation to the basket assembly 18, the reactor system 10 promotes the rate of chemical reaction between the catalyst and the chemical reagent without the catalyst itself being consumed or undergoing a chemical change. Although a granular catalyst is disclosed therein, it will be appreciated by those skilled in the art that suitable catalysts may be inorganic, organic, or complex organic groups and metal halides. Alternatively, the catalysts that may be confined within the annular space 24 may be in solid, rather then granular form. Thus, the reactor system 10 promotes the kinetics of mixing and therefore effectiveness of the granular catalyst with the chemical reagent for a given electrical power consumption. The inventor has found that the disclosed reactor system also enhances the control that can be asserted by the operator over the chemical reaction and enable the results to readily be reproduced.

In one embodiment, the cylindrical baskets are formed from a screen with an average mesh size α. The granular catalyst is prepared such that it has a smallest grain size β. To contain the granular catalyst within the annular space 24 between the basket 20, 22, β exceeds α. One illustrative mesh size is 0.013 wire gage, 30×30 mesh stainless steel. The mesh size may be selected depending upon the particle of grain size of the granular catalyst.

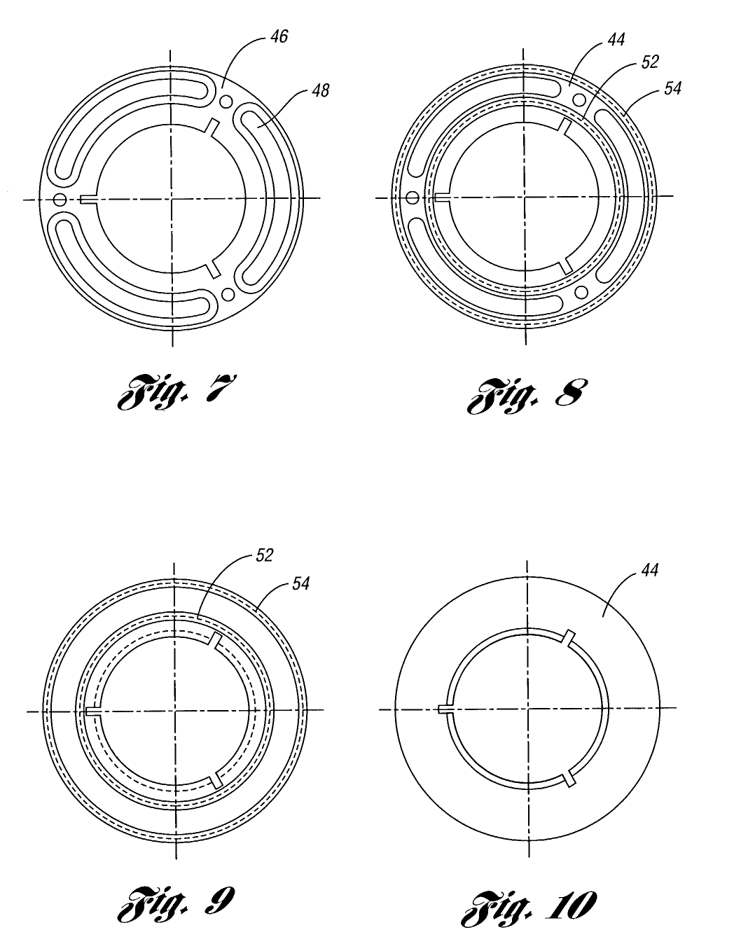

Turning now to FIGS. 5-10, there are depicted additional members of the reactor system 10. They include a lower end cap 44 (FIG. 8) and an upper end cap 46 (FIG. 6) between which the baskets 20, 22 extend. Although not depicted, if desired, a loop may be provided on the upper side of the top end cap to facilitate removal of the basket. As shown in FIGS. 6-8, the upper end cap is provided with one or more apertures 48 that enable the annular space 24 to be filled with and emptied by the granular catalyst. In FIG. 7, details of the upper end cap are depicted, including (preferably) a 45° chamfer that surrounds three depicted apertures in order to facilitate catalyst loading. Preferably, the apertures are provided with chamfered peripheries to facilitate the loading of the granular catalyst. After charging the annular space with the granular catalyst, a cover 50 (FIG. 2) closes off the apertures.

FIGS. 5-6 illustrate how the basket assembly 18 fits within the bore 14 of the reactor 12. In practice, the basket assembly 18 is secured in relation to the bore 14 so that the former does not rotate in relation to the latter.

In FIG. 8, an underside view of the upper end cap is depicted which illustrates grooves that are provided to accommodate the baskets. FIGS. 9 and 10 respectively illustrate the lower end cap (top view) including screen grooves that support the base of each basket. FIG. 10 depicts slots that are sized for registry with inner baffle bars that secure the basket assembly in relation to the bore and impede axial flow inside the baskets.

During assembly, the basket assembly is hand fit to the reactor bore by sanding or grinding the outer baffles. The basket assembly, as noted earlier, includes inner and outer baskets 20,22. Each basket 20,22 is formed from a mesh or screen which is configured cylindrically. The screen cylinders are overlapped and spot welded at intervals.

Although various capacities of reactor/vessel can be used, in practice a 300 cc reactor vessel and a 500 cc reactor vessel have been used with good effect. The reactor vessels are manufactured by Autoclave Engineers ((http://www.snap-tite.com). The 500 cc assembly is similar to the 300 cc version, but different in certain ways. When small particles are used in the granular catalyst, a fine screen is required to contain them. One consequence is that it is difficult to force reaction fluids through a defined catalyst particle bed and the two fine screen baskets. Accordingly, stir shaft-to-catalyst basket clearances need, to be about 0.040 inches between the upper and lower pumps and the basket to ensure that the pumps work at maximum efficiency with little pumping loss. The three inner baffle bars 17 between the catalyst bed and the stir shaft vertical blades tend to reduce internal liquid swirl and help direct the liquid through the screen and catalyst bed. Such baffles are absent from the 300 cc version because of its small size. The baffles, however, are preferred in the 500 cc version. Preferably, the 300 cc basket is about 4 inches in height, with a bore of about 1½ inches. The 500 cc basket has a depth of about 6 inches with a diameter of about 2 inches.

Thus, the continually stirred reactor system contains catalyst particles and efficiently circulates reaction liquids across the surfaces of and between the catalyst particles. The screen mesh size is chosen to be as large as possible and still contain the smallest catalyst particle from creating the least amount of resistence to liquid flow. The top pump draws the liquid down into the central section, while the lower pump urges liquid up into the central section. Attached to the central shaft between the upper and lower pumps are four vertical blades that re-direct the liquid from a vertical motion to a radial motion. Thus, the liquid is redirected outwardly, through the catalyst bed, to the reactor wall and can then continue circulating in this manner as long as the impeller is running.

In one example the disclosed reactor system is used in the hydrogenation of acetophenone to methyl benzyl alcohol. In one series of experiments the typical hydrogenation catalyst of various particle sizes was exposed under pressures between 200-1500 psig and temperatures between 50-250° C. Stirrer RPMs varied between 200-2000 RPMs.

While embodiments of the invention have been illustrated and described, it is not intended that these embodiments illustrate and describe all possible forms of the invention. Rather, the words used in the specification are words of description rather than limitation. It is understood that various changes may be made without departing from the spirit and scope of the invention.

What is claimed is:

1. A reactor system for use in chemical processing, comprising:
a reactor having a longitudinal cylindrical bore with a shaped bearing carrier;
a basket assembly that is received in the bore so that the basket assembly is secured in relation thereto, the basket assembly including
an inner, generally cylindrical basket; and
an outer, generally cylindrical basket that is coaxial with the inner basket, the inner and outer baskets defining an annular space therebetween, the annular space being adapted to accommodate a granular catalyst therewithin;
a rotatable shaft assembly extending axially within the bore, the shaft assembly including an upper end, a lower end and a central section extending therebetween, the upper and lower ends each having a pump for directing flow of a chemical reagent axially toward the central section upon rotation of the shaft assembly, the central section being provided with radially extending blades for urging flow of the reagent outwardly through the annular space between the baskets,
whereby the reactor system promotes flow and mixing between the chemical reagent and the catalyst, thereby enhancing the kinetics of chemical reaction, control, and the reproducibility thereof.

2. The reactor system of claim 1, wherein the cylindrical baskets comprise screens having an average mesh size α and the granular catalyst has a smallest grain size β, wherein β exceeds α.

3. The reactor system of claim 1, wherein the basket assembly includes a lower end cap and an upper end cap between which the baskets extend.

4. The reactor system of claim 3, wherein the upper end cap is provided with one or more apertures to permit the annular space to be filled and emptied.

5. The reactor system of claim 3, wherein the upper end cap and the lower end cap are provided with concentric annular grooves which receive the inner and outer baskets.

6. The reactor system of claim 4, further including a cover fastened to the upper end cap to seal the one or more apertures and confine the catalyst within the annular space.

7. The reactor system of claim 1, wherein
the radially extending blades comprise four blades that redirect during rotation of the shaft the chemical reagent from a vertical motion inside the inner basket to a radial motion outwardly through the granular catalyst that is confined within the annular space between the inner basket and the outer basket before the reagent impinges upon the cylindrical bore and continues upwardly toward the pump located at the upper end and downwardly toward the pump located at the lower end of the shaft assembly, the reagent thereby tracing a recirculating, closed path.

8. A method of using the reactor system of claim 1, comprising the steps of:
assembling the reactor system;
loading the catalyst within the annular space;
adding the chemical reagent into the bore;
fastening the cover to the upper end cap; and
rotating the shaft assembly under preselected conditions of rotational speed on electrical power consumption.
